(19) United States
(12) Patent Application Publication
(10) Pub. No.: US 2003/0089875 A1
(43) Pub. Date: May 15, 2003

(54) Control valve stem split guide bushing

(76) Inventor: Randy Jerold Hall, Marshalltown, IA (US)

Correspondence Address: MARSHALL, GERSTEIN & BORUN, 6300 SEARS TOWER, 233 SOUTH WACKER, CHICAGO, IL, 60606-6357, US

(21) Appl. No.: 10/152,602

(22) Filed: May 21, 2002

Related U.S. Application Data
(60) Provisional application No. 60/335,922, filed on Nov. 15, 2001.

(51) Int. Cl. F16K 31/44

(52) U.S. Cl. 251/214

(57) ABSTRACT

A fluid control valve includes a valve body, having a fluid inlet passage, and a fluid outlet passage. The control valve further includes a valve stem and a one-piece self-retaining bushing that guides the valve stem. A shouldered portion on the one-piece self retaining bushing is adapted to engage with a valve component.

### RELATED APPLICATION DATA

This application claims the benefit of provisional application Serial No. 60/335,922, which was filed Nov. 15, 2001, entitled “CONTROL VALVE STEM SPLIT GUIDE BUSHING.”

### FIELD OF THE DISCLOSURE

The disclosure relates generally to control valves and more particularly to control valves having stem guide bushings.

### BACKGROUND OF THE DISCLOSURE

Control valves are used in a wide number of process control system applications to control some parameter of a process fluid (i.e. a liquid, gas, slurry, etc.). While the process control system may use a control valve to ultimately control the pressure, level, pH or other desired parameter of a fluid, the control valve basically controls the rate of fluid flow.

Typically, a control valve may include a fluid inlet passage coupled through an orifice to a fluid outlet and a closure member disposed in the orifice which controls the amount of fluid flow therethrough. The closure member may include a valve plug having a surface which seats against a seat ring disposed at the orifice. During operation, the process control system, or an operator controlling the control valve manually, moves the valve plug towards and away from a surface of the seat ring to provide a desired fluid flow through the orifice and through the control valve.

During operation of the valve, many components suffer wear due to repeated and extensive cycling of the valve components, specifically the valve stem and the components in contact with the valve stem. Furthermore, wear can occur as fluid flow creates sideloading on the valve stem during actuator movement. This wear problem is sometimes even further accentuated when metal to metal contact between the valve stem and another contacting components occurs. The resulting problems from the wear include, but are not limited to, diminished life span of the valve and parts, undesirable leakage and misalignment of the valve stem. Therefore, bushings have been incorporated into valves to reduce the wear of valve components, to provide improved guidance to the valve stem, and to align the different valve components. More specifically, by aligning the valve plug with the seat ring, a better valve shutoff is achieved, and similarly, by aligning the valve stem with the packing, the leakage past the packing is reduced.

In the past, attempts have been made to provide for such a bushing using a two-piece bushing or using a one-piece bushing with adhesive to secure the bushing in a proper position within the control valve. Each of the above named solutions, however, have not completely resolved the issues at hand. A two-piece bushing is not cost effective, and is susceptible to separation during operation. Similarly, a one-piece bushing retained by an adhesive can be difficult to install and remove and is also susceptible to separation during operation.

### SUMMARY OF THE DISCLOSURE

In accordance with one aspect of the disclosure, an improved bushing that is cost effective to manufacture, install and remove, and which will remain secure during operation of the valve, is disclosed.

In accordance with another aspect of the disclosure, a control valve, includes a fluid inlet passage, a fluid outlet passage, and an orifice connecting the fluid inlet passage to the fluid outlet passage. The control valve also includes a valve stem being operatively coupled to a valve plug, such that the valve plug opens and closes the orifice, and a one-piece self-retaining bushing disposed between the valve stem and a valve component, wherein the one-piece self-retaining bushing is adapted to engage with the valve component for guiding the valve stem.

### BRIEF DESCRIPTION OF THE DRAWINGS

The advantages of the present invention will be apparent upon reading the following description in conjunction with the drawings, in which:

FIG. 1 is a cross-sectional view of a fluid valve, including a valve stem, a valve plug, a packing assembly and stem guide bushings;

FIG. 2 is a detailed view of a packing nut, the valve stem, the packing nut and a stem guide bushing of FIG. 1;

FIG. 3 is an isometric view of the stem guide bushing of FIG. 2;

FIG. 4 is a partial cross-sectional view of the packing nut and the stem guide bushing of FIG. 2, during insertion of the stem guide bushing into the packing nut;

FIG. 5 is a partial cross-sectional view of the packing nut, the valve stem and the stem guide bushing of FIG. 4, after insertion of the stem guide bushing into the packing nut and insertion of the valve stem into the packing nut and stem guide bushing; and

FIG. 6 is a detailed partial cross-sectional view of the packing nut and the stem guide bushing of FIG. 4.

While the invention is susceptible to various modifications and alternative constructions, certain illustrative embodiments thereof have been shown in the drawings and will be described below in detail. It should be understood, however, that there is no intention to limit the invention to the specific forms disclosed, but on the contrary, the intention is to cover all modifications, alternative constructions, and equivalents falling within the spirit and scope of the invention.

### DETAILED DESCRIPTION

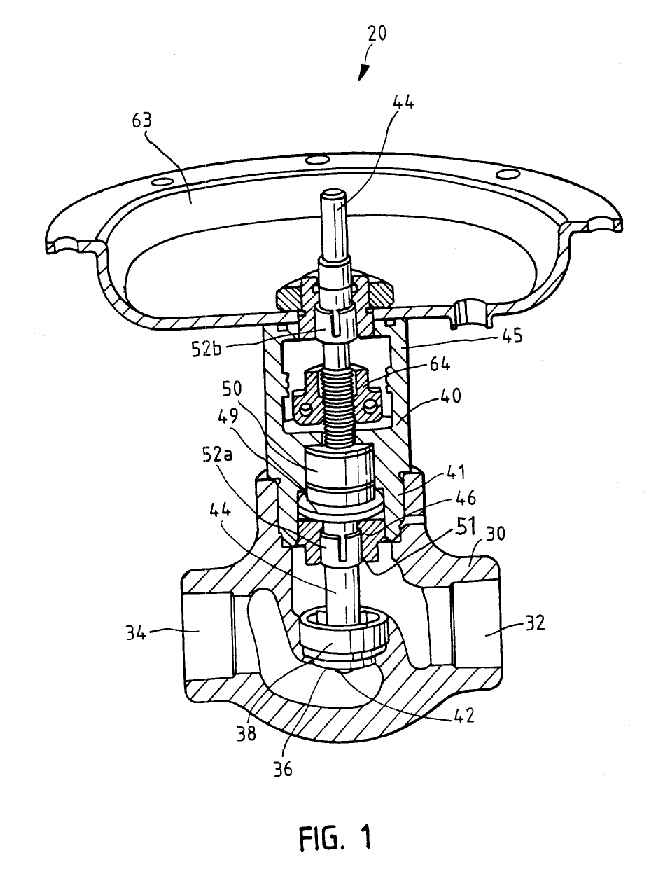

Referring now to the drawings, and with specific reference initially to FIG. 1, a control valve is generally indicated by reference numeral 20. The control valve 20 includes a valve body 30, a fluid inlet passage 32, a fluid outlet passage 34, and an orifice 36 coupling the fluid inlet passage 32 to the fluid outlet passage 34. A valve plug 42 is coupled by a valve stem 44, that extends through a bonnet 40, to an actuator (not shown). The actuator may include a diaphragm casing 63. In an alternate example, the fluid inlet passage 32 and the fluid outlet passage 34 may be reversed, such that the fluid inlet passage 32 becomes an outlet passage and the fluid outlet passage 34 becomes an inlet passage.

A one-piece self-retaining stem guide bushing 52a, may be concentrically located between the valve stem 44 and a packing nut 46. The packing nut 46 may include an exterior side exposed to the fluid inlet passage 32, an interior side abutting washers 49, and a bore 51 disposed in the center of the packing nut 46. The packing nut 46 may be threadably attached to a lower portion 41 of the bonnet 40, as oriented in FIG. 1. Also surrounding the valve stem 44, within the bonnet 40, may be the washers 49, such as belleville washers, and a packing assembly 50.

Located within the bonnet 40, may be a travel limiting device 64, that limits the linear travel of the valve stem 44, and a second one-piece stem guide bushing 52b. The actuator (not shown) may, during operation of the control valve 20, move the valve stem 44 and the valve plug 42 towards and away from a seat ring 38 to close and open, respectively, the control valve 20.

Above the fluid inlet passage 32, may be the packing nut 46 and the first stem guide bushing 52a, both surrounding the valve stem 44. Both the packing nut 46 and the valve stem 44 may be constructed from stainless steel or any other suitable material.

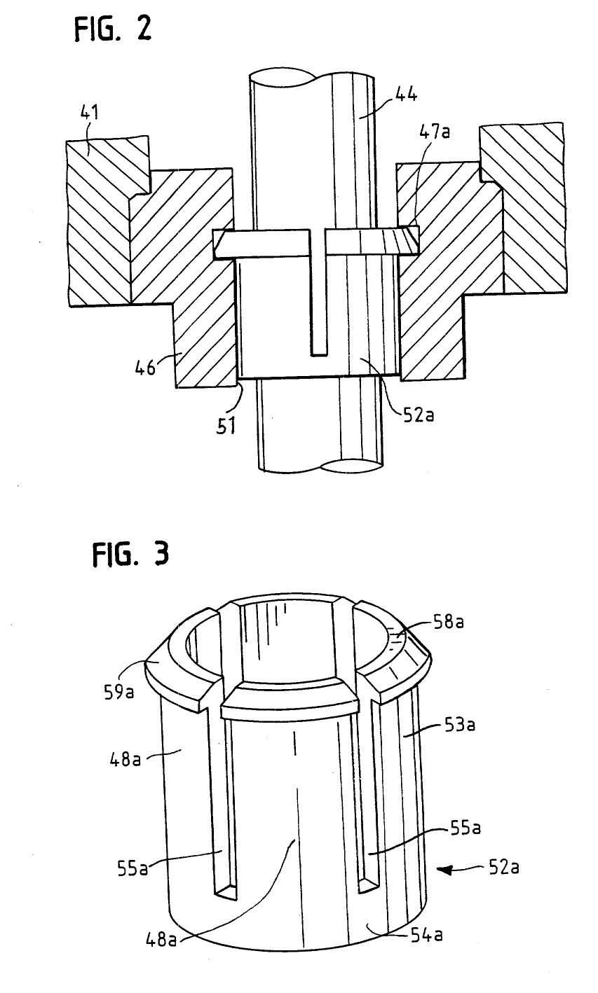

Now generally referring to FIG. 2, the exterior surface of the packing nut 46 may be adapted to threadably engage with the lower portion 41 of the bonnet 40. The lower portion 41 of the bonnet 40, and the bonnet 40, may be constructed of carbon steel or any other suitable material. The packing nut 46 may be adapted to surround and captivate the stem guide bushing 52a. The packing nut 46 may have disposed in the bore 51 an annular groove 47a, that may be located a sufficient distance from the exposed end of the packing nut 46 to allow complete insertion of the stem guide bushing 52a into the packing nut 46, thereby enabling the packing nut 46 to capture the stem guide bushing 52a.

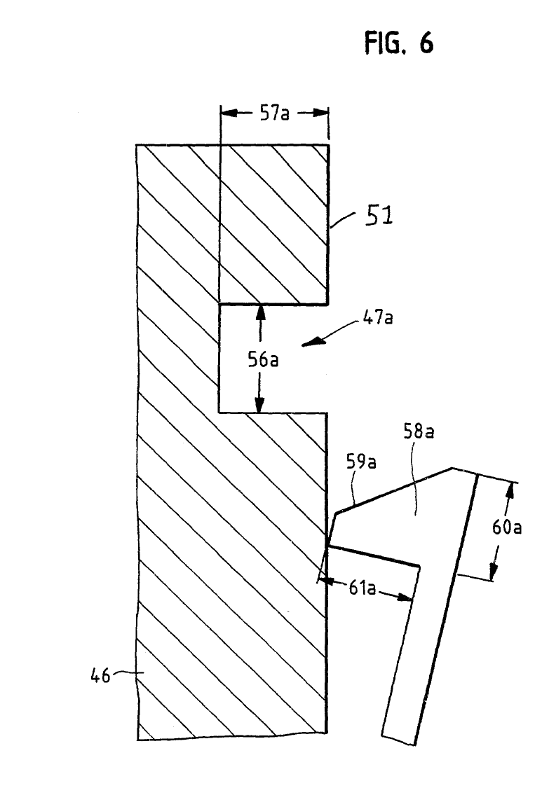

As can be best seen in FIGS. 3 and 6, the height 56a and depth 57a of the annular groove 47a, are also adapted to retain a shouldered portion 58a contained on the first end 53a of the stem guide bushing 52a. The depth 57a of the annual groove 47a may be greater than that of the width 61a of the shouldered portion 58a of the stem guide bushing 52a, to ensure that the exterior surface of the stem guide bushing 52a abuts the bore 51 of the packing nut 46. Likewise, the height 56a of the annual groove 47a may be slightly greater than the height 60a of the shouldered portion 58a of the stem guide bushing 52a, to ensure a non interference fit between the annular groove 47a and the shouldered portion 58a.

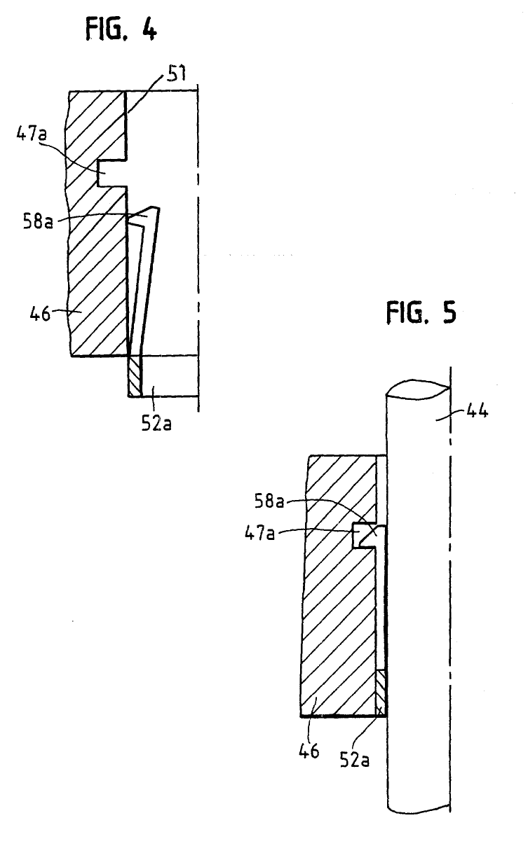

Now referring to FIGS. 3-5, the stem guide bushing 52a may be constructed of a low friction material such as Polyphenlyene Sulfide (PPS), or any other material suitable for its intended purpose, and may, as mentioned above, be adapted to retain itself within the packing nut 46. The stem guide bushing 52a may have a wall thickness adapted to achieve a sliding fit between the valve stem 44 and the packing nut 46. On a second end 54a, the stem guide bushing 52a may have a contiguous, unbroken surface, whereas on a first end 53a, the stem guide bushing 52a may have at least one slot, but preferably four slots 55a, originating on the first end 53a of the stem guide bushing 52a and thereby creating an equal number of prongs 48a.

The length of the slots 55a may be, for example, 3i4 of the distance between the first end 53a and the second end 54a of the stem guide bushing 52a, but the slots 55a could be any length, or even omitted, depending on the material, size, and thickness of the stem guide bushing 52a. On the first end 53a, the stem guide bushing 52a may also contain a shouldered portion 58a, properly dimensioned to engage the annular groove 47a as discussed above.

Furthermore, the shouldered portion 58a may include a chamfered edge 59a on the annular outer end of the shouldered portion 58a. The chamfered edge 59a may be appropriately dimensioned and located, such that when the first end 53a of the stem guide bushing 52a concentrically contacts the exposed edge of the packing nut 46, the chamfered edge 59a may aid in the inward deflection of the stem guide bushing prongs 48a during insertion of the stem guide bushing 52a into the packing nut 46.

The number of stem guide bushings in the valve 20, may vary from as few as one, to several stem guide bushings. Likewise, a stem guide bushing may be located anywhere along the valve stem 44, within the valve 20. For example, as shown and oriented in FIG. 1, the second stem guide bushing 52b may be located within the upper portion 45 of the bonnet 40, and the first stem guide bushing 52a may be located within the packing nut 46. There may be additional stem guide bushings located in either the packing nut 46, the upper portion 45 of the bonnet 40, or in a different valve component. Similar to stem guide bushing 52a located in the packing nut 46, the second stem guide bushing 52b and any other stem guide bushing, may be shaped in a similar fashion, and may be adapted to retain its position within the upper portion 45 of the bonnet 40, or within any other valve component or combination of components.

Immediately prior to insertion of the stem guide bushing 52a into the packing nut 46, the prongs 48a of the stem guide bushing 52a may be compressed toward the axial center of the stem guide bushing 52a, effectively reducing the outside diameter of the first end 53a of the stem guide bushing 52a. This reduction of the outside diameter of first end 53a of the stem guide bushing 52a, may allow for the chamfered edge 59a of the shouldered portion 58a to transition the first end 53a of the stem guide bushing 52a into the packing nut 46. As the stem guide bushing 52a is pushed into the packing nut 46, the shouldered portion 58a of the stem guide bushing 52a may eventually engage the annular groove 47a located on the interior surface of the packing nut 46.

Once the shouldered portion 58a is engaged with the annular groove 47a, the interior surface of the stem guide bushing 52a may provide a substantially smooth bearing surface to slidingly support the valve stem 44. The shouldered portion 58a may also rest in the annular groove 47a of the packing nut 46 to prevent any substantial linear movement of the stem guide bushing 52a. Once the valve stem 44 is installed through the stem guide bushing 52a, as seen in FIG. 5, the valve stem 44 in combination with the annular groove 47a, will secure the stem guide bushing 52a in the packing nut 46 by limiting the shouldered portion 58a of the stem guide bushing 52a to remain engaged with the annular groove 47a, thereby preventing the shouldered portion 58a of the stem guide bushing 52a from being deflected and being extracted from the packing nut 46, during the operation of the valve 20.

In operation, one or more stem guide bushings 52a and 52b may be utilized in and with various valve components, including, but not limited to, the packing nut 46 and the bonnet 40, but a single stem guide bushing 52a will herein be described as being utilized within the packing nut 46. During assembly of the control valve 20, the stem guide bushing 52a may be preassembled into a valve component prior to the valve component being assembled into the control valve 20, or the stem guide bushing 52a may be assembled separately into the control valve 20. For example, the stem guide bushing 52a may be preassembled into the packing nut 46 prior to installation of the packing nut 46 into the control valve 20. The stem guide bushing 52a may, however, be installed into the packing nut 46, after the packing nut 46 has been installed into the control valve 20.

More specifically, as seen in FIGS. 2-6, the first end 53a of the stem guide bushing 52a may be inserted into the generally cylindrical bore 51 disposed in the center of the packing nut 46. As the first end 53a of the stem guide bushing 52a penetrates the packing nut 46, the chamfered edge 59a of the shouldered portion 58a may aid in the insertion of the stem guide bushing 52a into the packing nut 46, by deflecting the prongs 48a of the stem guide bushing 52a, toward the axial center of the stem guide bushing 52a. As the stem guide bushing 52a is further inserted into the packing nut 46, the prongs 48a may be further deflected toward the axial center of the stem guide bushing 52a, until the entire shouldered portion 58a is located in the packing nut 46. The stem guide bushing 52a may be further inserted into the packing nut 46, until the shouldered portion 58a expands into the annular groove 47a of the packing nut 46, thereby securing the stem guide bushing 52a in the packing nut 46.

Once the stem guide bushing 52a is secure, the exterior surface of the stem guide bushing 52a and the bore 51 of the packing nut 46 may be concentric and may be substantially parallel to each other, such that the interior surface of the stem guide bushing 52a may slidingly engage with the valve stem 44. Similarly, the shouldered portion 58a of the stem guide bushing 52a may rest in the annular groove 47a, such that the area of the shouldered portion 58a bounded by dimensions 60a and 61a is less than or equal to the area of the annular groove 47a bounded by dimensions 56a and 57a, respectively, thereby enabling the prongs 48a of the stem guide bushing 52a and the bore 51 of the packing nut 46 to remain concentric and parallel to each other by ensuring the full recession of the shouldered portion 58a into the annular groove 47a.

Once assembled, the valve stem 44, being operatively connected to the valve plug 42, may move up and down to enable the opening and closing of the orifice 36. During the repetitive movement of the valve stem 44, the self-retaining stem guide bushing 52a may be slidingly engaged with the valve stem 44.

The foregoing detailed description has been given for clearness of understanding only and no unnecessary limitations should be understood therefrom, as modifications will be apparent to those skilled in the art.

What is claimed is:

1. A control valve comprising:
a valve body having a fluid inlet passage and a fluid outlet passage;
a valve stem being operatively coupled to a valve plug, wherein the valve plug opens and closes an orifice located between the fluid inlet passage and the fluid outlet passage; and
a one-piece self-retaining bushing, having a first end, a second end, and a shouldered portion disposed between the valve stem and a valve component, wherein the one-piece self-retaining bushing is adapted to engage with the valve component.

2. The control valve of claim 1, wherein the one-piece self-retaining bushing is constructed from Polyphenlyene Sulfide.

3. The control valve of claim 1, wherein the one-piece self-retaining bushing includes at least one slot extending from the first end of the one-piece self-retaining bushing toward the second end of the one-piece self-retaining bushing.

4. The control valve of claim 1, wherein the first end of the one-piece self-retaining bushing is able to deflect toward an axial center of the bushing.

5. The control valve of claim 1, wherein the shouldered portion has a chamfered edge.

6. A control valve comprising:
a housing having a fluid inlet passage and a fluid outlet passage;
a valve stem being operatively coupled to a valve plug, wherein the valve plug opens and closes an orifice located between the fluid inlet passage and the fluid outlet passage; and
a valve component having a bore adapted to receive a one-piece self-retaining bushing, such that the one-piece self-retaining bushing is disposed between the valve stem and a valve component.

7. The control valve of claim 6, wherein the valve component includes an annular groove on the interior surface of the bore adapted to receive the one-piece self-retaining bushing.

8. The control valve of claim 6, wherein the valve component is a bonnet.

9. The control valve of claim 6, wherein the valve component is a packing nut.

10. A control valve comprising:
a valve body having a fluid inlet passage and a fluid outlet passage;
a valve stem being operatively coupled to a valve plug, wherein the valve plug opens and closes an orifice located between the fluid inlet passage and the fluid outlet passage;
a one-piece self-retaining bushing, having a first end, a second end, and a shouldered portion;
a valve component, having a bore adapted to receive the one-piece self-retaining bushing;
wherein the one-piece self-retaining bushing is adapted to engage with the valve component, and the one-piece self-retaining bushing is disposed between the valve stem and a valve component.

11. The control valve of claim 10, wherein the valve component includes at least one annular groove in the bore, adapted to secure the one-piece self-retaining bushing.

12. The control valve of claim 10, wherein the valve component is a bonnet.

13. The control valve of claim 10, wherein the valve component is a packing nut.

14. The control valve of claim 10, wherein the one-piece self-retaining bushing is constructed from Polyphenlyene Sulfide.

15. The control valve of claim 10, wherein the one-piece self-retaining bushing includes at least one slot extending from the first end of the one-piece self-retaining bushing toward the second end of the one-piece self-retaining bushing.

16. The control valve of claim 10, wherein the first end of the one-piece self-retaining bushing is able to deflect toward an axial center of the one-piece self-retaining bushing.

17. The control valve of claim 10, wherein the shouldered portion has a chamfered edge.

18. A one-piece self-retaining bushing, comprising:
a generally cylindrical body having a first end, a second end, and an annular shouldered portion disposed near the first end of the body; and
the annular shouldered portion adapted to engage with an annular groove in a valve component.

19. The one-piece self-retaining bushing of claim 18, wherein the one-piece self-retaining bushing further includes at least one slot originating from the first end of the one-piece self-retaining bushing toward the second end of the one-piece self-retaining bushing.

20. The control valve of claim 18, wherein the one-piece self-retaining bushing is constructed from Polyphenlyene Sulfide.

21. The one-piece self-retaining bushing of claim 18, wherein the annular shouldered portion has a chamfered edge.

22. The one-piece self-retaining bushing of claim 18, wherein the first end of the bushing is able to deflect toward an axial center of the bushing.

23. A method of installing a one-piece self-retaining bushing, comprising the steps of:
providing a valve including a valve stem, a valve component and a one-piece self-retaining bushing, wherein the one-piece self-retaining bushing includes a first end and a second end;
engaging a shouldered portion located on the first end of the one-piece self-retaining bushing with an annular groove of a valve component; and
inserting the valve stem within the one-piece self-retaining bushing.

24. The method of claim 23, further including the step of compressing the first end of the one-piece self-retaining bushing toward an axial center of the one-piece self-retaining bushing.

25. The method of claim 23, further including the step of engaging a chamfered edge located on the shouldered portion of the stem guide bushing with a valve component.
